(19) United States
(12) Patent Application Publication
(10) Pub. No.: US 2025/0265555 A1
(43) Pub. Date: Aug. 21, 2025

(54) SYSTEM AND METHOD FOR TRANSFER OF FUNDS

(71) Applicant: Private Auto Inc., Alpine, UT (US)

(72) Inventor: Bradley Parker, Alpine, UT (US)

(73) Assignee: Private Auto Inc., Alpine, UT (US)

(21) Appl. No.: 18/443,249

(22) Filed: Feb. 15, 2024

(51) Int. Cl. G06Q 20/10; G06Q 20/40

(52) U.S. Cl. CPC G06Q 20/10; G06Q 20/405

(57) ABSTRACT

A computer-implemented method includes establishing a Seller Internal Bank Account for a seller and a Buyer Internal Bank Account for a buyer under a Financial Custodian. The computer-implemented method further includes determining whether terms of a sale agreed to by the buyer match terms of a sale agreed to by the seller. The computer-implemented method further includes performing an intrabank transfer of funds from the Buyer Internal Bank Account to the Seller Internal Bank Account upon determining that the terms of the sale agreed to by the buyer match the terms of the sale agreed to by the seller, where the seller is granted immediate access to the funds.

### FIELD

This disclosure relates generally to a system and method for transferring funds quickly and easily. More particularly, embodiments of the invention relate to systems and methods for transferring funds quickly and easily with security for the buyer and seller. In a particular embodiment, the transferring of funds occurs in conjunction with a motor vehicle sale transaction.

### BACKGROUND

Large dollar transactions for sale of items such as motor vehicles can be difficult to navigate for many people. Such transactions are typically done between individuals without any prior relationship. Such transactions have typically required a third-party broker or other means where the delivery of funds and the delivery of the item for sale and/or title was facilitated by the neutral third party. In such transactions, there are many pitfalls and opportunities for parties to be taken advantage of. In addition, funds may be sequestered and not available for a period of time while the transaction is settled. Conventional systems may have certain limitations in their ability to navigate these issues to the satisfaction of consumers. Use of other forms of payments including cash or check will be susceptible to fraud and theft. The uncertainty of the transaction makes it so many parties are reluctant to even sell a high value motor vehicle to another private party. Although conventional systems can effectuate a transaction, they cannot yet do so instantaneously by the systems and methods set herein and accomplish what is set forth herein.

Conventional systems have shortcomings in their ability to effectuate hassle free and instantaneous transfer of funds. Embodiments herein overcome such shortcomings allowing for the instantaneous transfer of funds from a buyer to a seller which allows the seller to be confident in the transaction and utilize the funds quickly without waiting for holds.

The subject matter of the present application has been developed in response to the present state of the art, and in particular, in response to the problems and disadvantages associated with conventional systems that have not yet been fully solved by currently available techniques. Accordingly, the subject matter of the present application has been developed to provide embodiments of a system and method that overcomes at least some of the shortcomings of prior art techniques.

### SUMMARY

Disclosed herein is a computer-implemented method. The computer-implemented method includes establishing a Seller Internal Bank Account for a seller and a Buyer Internal Bank Account for a buyer under a Financial Custodian. The computer-implemented method further includes determining whether the terms of a sale agreed to by the buyer match terms of a sale agreed to by the seller. The computer-implemented method further includes performing an intrabank transfer of funds from the Buyer Internal Bank Account to the Seller Internal Bank Account upon determining that the terms of the sale agreed to by the buyer match the terms of the sale agreed to by the seller, where the seller is granted immediate access to the funds. The preceding subject matter of this paragraph characterizes example 1 of the present disclosure.

The computer-implemented method further includes sending sale documentation for signature to the seller with the terms agreed to by the buyer. The preceding subject matter of this paragraph characterizes example 2 of the present disclosure, wherein example 2 also includes the subject matter according to example 1, above.

The computer-implemented method further includes sending sale documentation for signature to the buyer with the terms agreed to by the seller. The preceding subject matter of this paragraph characterizes example 3 of the present disclosure, wherein example 3 also includes the subject matter according to any one of examples 1-2, above.

The computer-implemented method further includes determining that the sale documentation for signature has been signed by the buyer and the seller before performing the intrabank transfer of the funds from the Buyer Internal Bank Account to the Seller Internal Bank Account. The preceding subject matter of this paragraph characterizes example 4 of the present disclosure, wherein example 4 also includes the subject matter according to any one of examples 1-3, above.

The computer-implemented method further includes funding the Buyer Internal Bank Account from a Buyer External Bank Account associated with the buyer. The preceding subject matter of this paragraph characterizes example 5 of the present disclosure, wherein example 5 also includes the subject matter according to any one of examples 1-4, above.

The computer-implemented method further includes determining the terms of the sale agreed to by the buyer. The preceding subject matter of this paragraph characterizes example 6 of the present disclosure, wherein example 6 also includes the subject matter according to any one of examples 1-5, above.

The computer-implemented method further includes determining the terms of the sale agreed to by the seller. The preceding subject matter of this paragraph characterizes example 7 of the present disclosure, wherein example 7 also includes the subject matter according to any one of examples 1-6, above.

Disclosed herein is a computer system. The computer system includes one or more processors and memory including instructions which, when accessed by the one or more processors, cause the one or more processors to establish a Seller Internal Bank Account for a seller and a Buyer Internal Bank Account for a buyer under a Financial Custodian and determine whether terms of a sale agreed to by the buyer match terms of a sale agreed to by the seller. The memory includes further instructions which cause the one or more processors to perform an intrabank transfer of funds from the Buyer Internal Bank Account to the Seller Internal Bank Account upon determining that the terms of the sale agreed to by the buyer match the terms of the sale agreed to by the seller, where the seller is granted immediate access to the funds. The preceding subject matter of this paragraph characterizes example 8 of the present disclosure.

The memory includes further instructions which cause the one or more processors to send sale documentation for signature to the seller with the terms agreed to by the buyer. The preceding subject matter of this paragraph characterizes example 9 of the present disclosure, wherein example 9 also includes the subject matter according to any one of examples 1-8, above.

The memory includes further instructions which cause the one or more processors to send sale documentation for signature to the buyer with the terms agreed to by the seller. The preceding subject matter of this paragraph characterizes example 10 of the present disclosure, wherein example 10 also includes the subject matter according to any one of examples 8-9, above.

The memory includes further instructions which cause the one or more processors to determine that the sale documentation for signature has been signed by the buyer and the seller before performing the intrabank transfer of the funds from the Buyer Internal Bank Account to the Seller Internal Bank Account. The preceding subject matter of this paragraph characterizes example 11 of the present disclosure, wherein example 11 also includes the subject matter according to any one of examples 8-10, above.

The memory includes further instructions which cause the one or more processors to fund the Buyer Internal Bank Account from a Buyer External Bank Account associated with the buyer. The preceding subject matter of this paragraph characterizes example 12 of the present disclosure, wherein example 12 also includes the subject matter according to any one of examples 8-11, above.

The memory includes further instructions which cause the one or more processors to determine the terms of the sale agreed to by the buyer. The preceding subject matter of this paragraph characterizes example 13 of the present disclosure, wherein example 13 also includes the subject matter according to any one of examples 8-12, above.

The memory includes further instructions which cause the one or more processors to determine the terms of the sale agreed to by the seller. The preceding subject matter of this paragraph characterizes example 14 of the present disclosure, wherein example 14 also includes the subject matter according to any one of examples 8-13, above.

Disclosed herein is a computer system. The computer system includes a core engine comprising one or more processors and configured to establish a Seller Internal Bank Account for a seller and a Buyer Internal Bank Account for a buyer under a Financial Custodian, determine whether terms of a sale agreed to by the buyer match terms of a sale agreed to by the seller, and perform an intrabank transfer of funds from the Buyer Internal Bank Account to the Seller Internal Bank Account upon determining that the terms of the sale agreed to by the buyer match the terms of the sale agreed to by the seller, where the seller is granted immediate access to the funds. The preceding subject matter of this paragraph characterizes example 15 of the present disclosure.

The core engine comprising one or more processors is further configured to send sale documentation for signature to the seller with the terms agreed to by the buyer. The preceding subject matter of this paragraph characterizes example 16 of the present disclosure, wherein example 16 also includes the subject matter according to example 15, above.

The core engine comprising one or more processors is further configured to send sale documentation for signature to the buyer with the terms agreed to by the seller. The preceding subject matter of this paragraph characterizes example 17 of the present disclosure, wherein example 17 also includes the subject matter according to any one of examples 15-16, above.

The core engine comprising one or more processors is further configured to determine that the sale documentation for signature has been signed by the buyer and the seller before performing the intrabank transfer of the funds from the Buyer Internal Bank Account to the Seller Internal Bank Account. The preceding subject matter of this paragraph characterizes example 18 of the present disclosure, wherein example 18 also includes the subject matter according to any one of examples 15-17, above.

The core engine comprising one or more processors is further configured to fund the Buyer Internal Bank Account from a Buyer External Bank Account associated with the buyer. The preceding subject matter of this paragraph characterizes example 19 of the present disclosure, wherein example 19 also includes the subject matter according to any one of examples 15-18, above.

The core engine comprising one or more processors is further configured to determine the terms of the sale agreed to by the buyer and the seller. The preceding subject matter of this paragraph characterizes example 20 of the present disclosure, wherein example 20 also includes the subject matter according to any one of examples 15-19, above.

Other aspects and advantages of embodiments of the present invention will become apparent from the following detailed description, taken in conjunction with the accompanying drawings, illustrated by way of example of the principles of the invention.

### BRIEF DESCRIPTION OF DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered limiting of its scope, the subject matter will be described and explained with additional specificity and detail through the use of the drawings.

FIG. 1 depicts a schematic overall diagram of a system according to one or more embodiments of the present disclosure.

FIG. 2 depicts a schematic diagram of a computing system according to one or more embodiments of the present disclosure.

FIG. 3 depicts a schematic diagram of a system for transferring funds, according to one or more embodiments of the invention.

FIG. 4 depicts a schematic flow diagram of a method, according to one or more embodiments of the invention.

FIG. 5 depicts a schematic flow diagram of a method, according to one or more embodiments of the invention.

Throughout the description, similar reference numbers may be used to identify similar elements. The following list is an example of the reference numbers used in the accompanying drawings:

| Reference # | Designation |
|---|---|
| 12 | Computer System |
| 14 | Processing Unit |
| 16 | Bus |
| 18 | I/O Interface(s) |
| 20 | Network Adaptor(s) |
| 22 | Memory |
| 24 | RAM |
| 26 | Cache Memory |
| 28 | Storage Media |
| 60 | Network |
| 110 | Control System |
| 150 | Seller External Bank Account 150 |
| 160 | Buyer External Bank Account |
| 170 | Financial Custodian |
| 190 | Deal Database |
| 200 | Core Engine |
| 210 | Sale Documentation |
| 220 | Inputs |
| 225 | Storage |
| 235 | Transfer Engine |
| 240 | Settlement Engine |
| 270 | Buyer Internal Bank Account |
| 274 | Seller Internal Bank Account |
| 285 | Deal Validation Engine |

Throughout this application, similar designations or vocabulary may be used to identify similar elements, although the breadth of this disclosure should be understood to incorporate any alternatives and variations referenced within the specification (including the claims) and the accompanying drawings.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments describe a computer-implemented method. Other embodiments describe a computer system with one or more processors and memory including instructions which, when accessed by the one or more processors, cause the one or more processors to perform functions described herein. Other embodiments describe a computer system including a core engine which includes one or more processors and is configured to perform functions described herein.

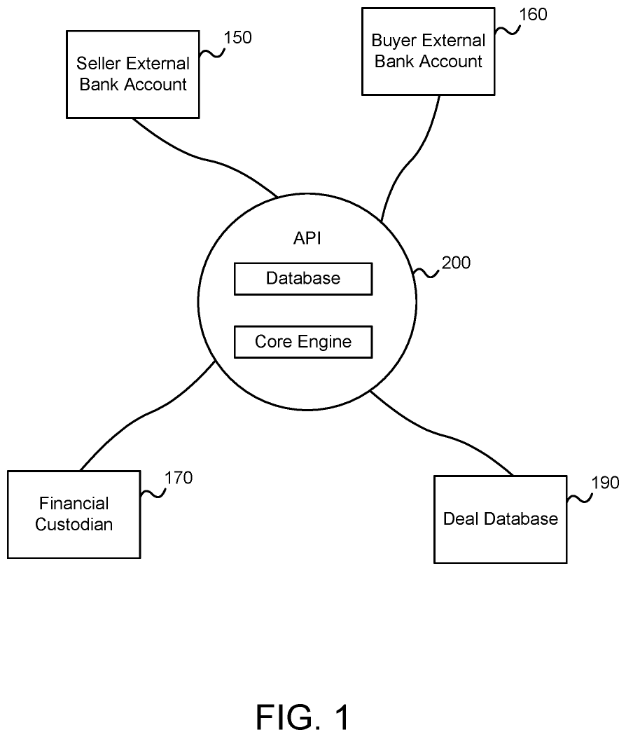

FIG. 1 depicts a schematic overall diagram of a system according to one or more embodiments of the present disclosure. Although the system is shown and described with certain components and functionality, other embodiments of the system may include fewer or more components to implement less or more functionality.

Referring to FIG. 1, a generalized understanding of embodiments of the invention is possible with respect to the overall system described with FIG. 1. The system includes a core engine 200. Although the core engine 200 is shown and described with certain components and functionality, other embodiments of the core engine 200 may include fewer or more components to implement less or more functionality.

The core engine 200 directly or via an API layer (application programming interface) communicates with various other components that may be internal or external with the core engine 200. The core engine 200 is an engine that is configured to verify internal and external bank accounts, analyze deal terms, verify sale documentation, and transfer funds from one internal bank account to another internal bank account instantly. The core engine 200 may be partially computer software based to carry out the functions that are set forth herein. The core engine 200 may have various sub-engines that are configured to perform the functions and tasks described herein. Although the sub-engines are shown and described with certain components and functionality, other embodiments of the sub-engines may include fewer or more components to implement less or more functionality.

A component that the core engine 200 communicates with includes, in some embodiments, a Buyer External Bank Account 160. The Buyer External Bank Account 160 may be located in a separate system that communicates with the core engine 200. In some implementations, the Buyer External Bank Account 160 may be communicated with through an online portal of a user's bank account. The online portal may have individualized data related to a user's particular bank account. In some implementations, a user is prompted by the core engine 200 to input the user's bank login information. Such bank login information may be used by the system to log in to a bank's system or a separate platform. In some implementations, the core engine 200 can be limited in what data are accessed. In some cases, information will be prompted of the buyer. Such inputs may include, but is not limited to, name, social security number and verification, phone, address, etc. Such information may be consistent with the set of processes known as Know Your Customer (KYC), a standard that banks typically follow to verify customers and their information.

The core engine 200, in some embodiments, may be configured to allow a user to input bank information. Upon verification of the buyer and their External Bank Account 160, the core engine 200 may create a Buyer Internal Bank Account 270 within a Financial Custodian 170. This internal bank account may be associated with the external bank account. Funds are then onboarded to the Buyer Internal Bank Account 270 in a manner consistent with Interbank transfers which is not described herein.

A similar process as to what was described above with the buyer is also performed with the seller. In this case, the core engine 200 communicates with Seller External Bank Account 150. The Seller External Bank Account 150 may be located in a separate system that communicates with the core engine 200. In some implementations, the Seller External Bank Account 150 may be communicated with through an online portal of the user's bank account. The online portal may have individualized data related to a user's (seller's) particular bank account. In some implementations, a user is prompted by the core engine 200 to input the user's bank login information. Such bank login information may be used by the system to log in to a bank's system or a separate platform. In some implementations, the core engine 200 can be limited in what data are accessed. In some cases, information will be prompted of the seller. Such inputs may include, but is not limited to, name, social security number and verification, phone, address, etc. Such information may be consistent with the set of processes known as Know Your Customer (KYC), a standard that banks typically follow to verify customers and their information. Such information may be stored in connection with the Seller External Bank Account 150.

The core engine 200, in some embodiments, may be configured to allow a user to input bank information. Upon verification of the seller and their External Bank Account 150, the core engine 200 may create a Seller Internal Bank Account 274 within the Financial Custodian 170. This internal bank account may be associated with the external bank account.

The Financial Custodian 170 allows for an intrabank transfer from the Buyer Internal Bank Account 270 to the Seller Internal Bank Account 274 to be possible. The intrabank nature of the transfer allows for the Financial Custodian to implement an instant transfer of funds between the accounts without any holds or waiting period. The seller is granted access to the funds immediately and can use and move the funds without delay.

The core engine 200, in some embodiments, is configured to facilitate the deal between the buyer and the seller. The core engine 200 may be configured to generate a seller portal and a buyer portal. The seller portal gives access to the seller to sale documentation 210. The sale documentation 210 will include information and legal documents related to the sale. Such documentation may include, but is not limited to, a bill of sale, vehicle information (such as VIN, make, model, year, mileage, etc.) or information for the item to be sold, the title, the offered sale price, and other pertinent information relating to the transaction. The buyer portal gives access to the buyer to the same information and sale documentation 210.

The core engine 200, in some embodiments, is configured to retrieve data from a deal database 190. The deal database 190 allows for the storage of information and documentation that is shown through the buyer portal and the seller portal.

In some embodiments, the buyer and the seller make offers and/or negotiate the particulars of the deal for the item to be sold. Once the particulars are agreed to (including the purchase price), the core engine 200 may be configured to generate the appropriate sale documentation 210. The sale documentation is then presented to the buyer and the seller for any and all signatures. Such signatures may be through E-sign or other electronic means.

Once the buyer and the seller have both signed the sale documentation, a deal validation engine 285 verifies that the buyer information matches the seller information and sale documentation indicates an agreed upon price for the item for sale.

Once the deal validation engine 285 verifies the information, a transfer engine 235 (a subcomponent of the core engine 200) may transfer the agreed upon funds via a settlement engine 240. The funds are transferred, and the seller is granted access to the funds instantly.

The instantaneous nature of the transfer without holds or waiting periods allows the user to have peace of mind regarding the transaction. Such intrabank transfer at the Financial Custodian 170 allows for a much more immediate settlement of the transaction than is possible with conventional systems. In addition, to the instantaneous access granted to the seller, the buyer no longer has access to the funds once the transfer occurs.

Information regarding the transaction may then be stored in storage 225 or another database along with the sale documentation 210.

The foregoing discussion is a general discussion of many of the processes present in some embodiments of the invention and the discussion is for illustrative purposes. Other embodiments may include variations of these processes.

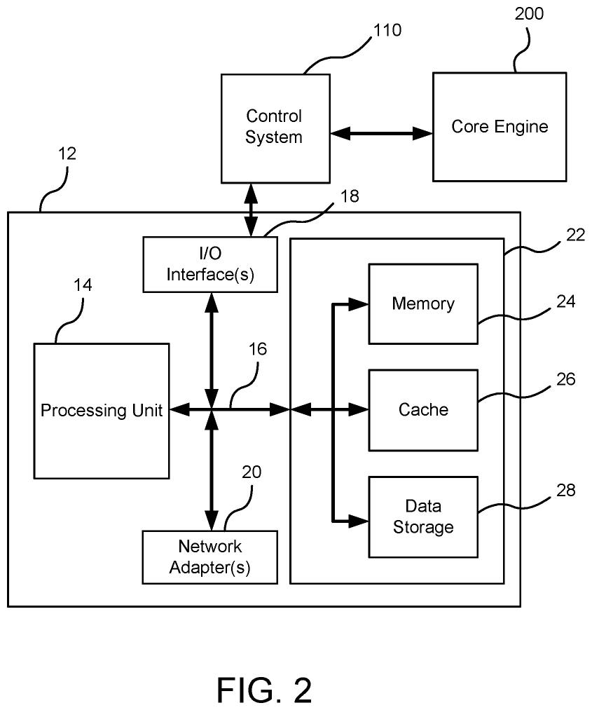

Referring now to FIG. 2, a schematic diagram of a computing system 100 is shown. Although the computing system 100 is shown and described with certain components and functionality, other embodiments of the computing system 100 may include fewer or more components to implement less or more functionality.

In some embodiments, aspects of the computing system 100 are implemented via a networked system or a computer system 12 or its component parts. The illustrated computer system 12 may include, but is not limited to, one or more processing arrangements, for example including processors or processing units 14, a communication bus 16, one or more input/output (I/O) adapters 18, one or more network adapters 20, and a system memory 22.

In one embodiment, the system memory 22 includes computer system readable media in the form of volatile memory, such as random-access memory (RAM) 24 and/or cache memory 26. The system memory 22 may further include other removable/non-removable, volatile/non-volatile computer system storage media 28. In such instances, each can be connected to the bus 16 by one or more data media interfaces. The memory 22 may include at least one program product having a set (e.g., at least one) of program modules that are configured to carry out the functions of proposed embodiments. For instance, the memory 22 may include a computer program product having program executable by the processing unit 14 to perform processes described herein. Programs and/or utilities having a set (at least one) of program modules may be stored in the memory 22. Program modules generally carry out the functions and/or methodologies described herein.

The computer system 12 may also communicate with one or more external devices such as a keyboard, a display, sensors 122, cameras, apps, or other external devices, including but not limited to a control system 110. Also, the computer system 12 can communicate with one or more networks such as a local area network (LAN), a general wide area network (WAN), and/or a public network (e.g., the Internet) via network adapter 20.

In the context of the present application, where embodiments of the present invention constitute a method, it should be understood that such a method is a process for execution by a computer, i.e. is a computer-implementable method. The steps of the method therefore reflect various parts of a computer program, e.g., parts of one or more algorithms. Embodiments of the present invention may be a system, a method, and/or a computer program product. The computer program product may include a computer readable storage medium (or media) having computer readable program instructions thereon for causing a processor to carry out aspects of the present invention.

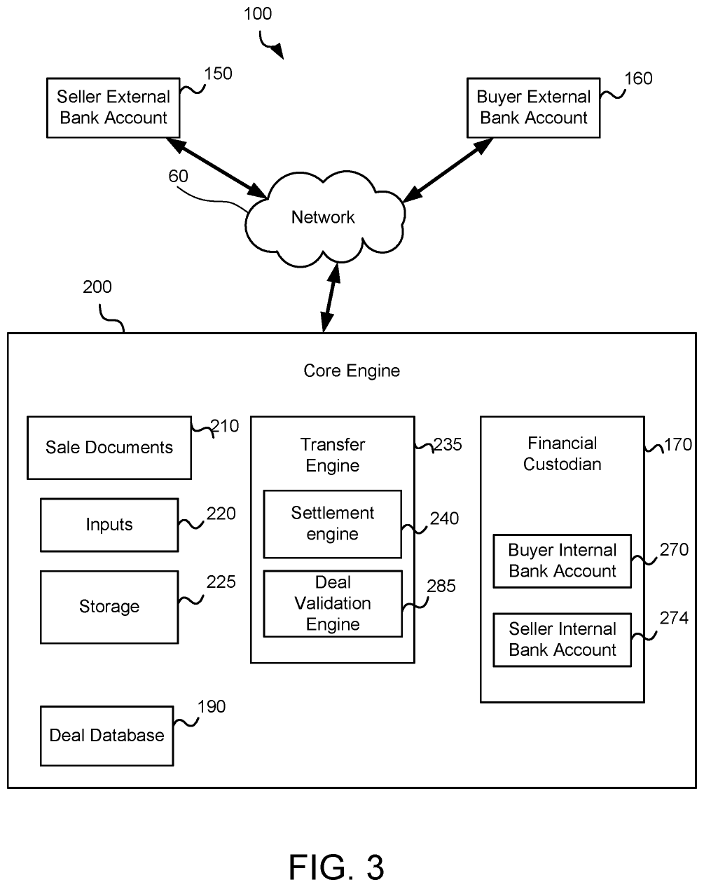

Referring to FIG. 2 again, the control system 110 interacts with and receives communication with the core engine 200. The control system 110 is further configured to control the system 100 and its function as the core engine communicates with the various components outlined in conjunction with FIG. 1 and what is outlined in conjunction with FIG. 3. In some embodiments, more than one control system 110 may control the various components of the system 100 or the general system 100.

Although the core engine 200 is shown and described with certain components and functionality, other embodiments of the core engine 200 may include fewer or more components to implement less or more functionality.

The core engine 200 directly or via an API layer (application programming interface) communicates with various other components that may be internal or external with the core engine 200. The core engine 200 is an engine that is configured to verify internal and external bank accounts, analyze deal terms, verify sale documentation, and transfer funds from one internal bank account to another internal bank account instantly. The core engine 200 may be partially computer software based to carry out the functions that are set forth herein. The core engine 200 may have various sub-engines that are configured to perform the functions and tasks described herein. Although the sub-engines are shown and described with certain components and functionality, other embodiments of the sub-engines may include fewer or more components to implement less or more functionality.

A component that the core engine 200 communicates with includes, in some embodiments, a Buyer External Bank Account 160. The Buyer External Bank Account 160 may be located in a separate system that communicates with the core engine 200. In some implementations, the Buyer External Bank Account 160 may be communicated with through an online portal of a user's bank account. The online portal may have individualized data related to a user's particular bank account. In some implementations, a user is prompted by the core engine 200 to input the user's bank login information. Such bank login information may be used by the system to log in to a bank's system or a separate platform. In some implementations, the core engine 200 can be limited in what data are accessed. In some cases, information will be prompted of the buyer. Such inputs may include, but is not limited to, name, social security number and verification, phone, address, etc. Such information may be consistent with the set of processes known as Know Your Customer (KYC), a standard that banks typically follow to verify customers and their information.

The core engine 200, in some embodiments, may be configured to allow a user to input bank information. Upon verification of the buyer and their External Bank Account 160, the core engine 200 may create a Buyer Internal Bank Account 270 within a Financial Custodian 170. This internal bank account may be associated with the external bank account. Funds are then onboarded to the Buyer Internal Bank Account 270 in a manner consistent with Interbank transfers which is not described herein.

A similar process as to what was described above with the buyer is also performed with the seller. In this case, the core engine 200 communicates with Seller External Bank Account 150. The Seller External Bank Account 150 may be located in a separate system that communicates with the core engine 200. In some implementations, the Seller External Bank Account 150 may be communicated with through an online portal of the user's bank account. The online portal may have individualized data related to a user's (seller's) particular bank account. In some implementations, a user is prompted by the core engine 200 to input the user's bank login information. Such bank login information may be used by the system to log in to a bank's system or a separate platform. In some implementations, the core engine 200 can be limited in what data are accessed. In some cases, information will be prompted of the seller. Such inputs may include, but is not limited to, name, social security number and verification, phone, address, etc. Such information may be consistent with the set of processes known as Know Your Customer (KYC), a standard that banks typically follow to verify customers and their information. Such information may be stored in connection with the Seller External Bank Account 150.

The core engine 200, in some embodiments, may be configured to allow a user to input bank information. Upon verification of the seller and their External Bank Account 150, the core engine 200 may create a Seller Internal Bank Account 274 within the Financial Custodian 170. This internal bank account may be associated with the external bank account.

The Financial Custodian 170 allows for an intrabank transfer from the Buyer Internal Bank Account 270 to the Seller Internal Bank Account 274 to be possible. The intrabank nature of the transfer allows for the Financial Custodian to implement an instant transfer of funds between the accounts without any holds or waiting period. The seller is granted access to the funds immediately and can use and move the funds without delay.

The core engine 200, in some embodiments, is configured to facilitate the deal between the buyer and the seller. The core engine 200 may be configured to generate a seller portal and a buyer portal. The seller portal gives access to the seller to sale documentation 210. The sale documentation 210 will include information and legal documents related to the sale. Such documentation may include, but is not limited to, a bill of sale, vehicle information (such as VIN, make, model, year, mileage, etc.) or information for the item to be sold, the title, the offered sale price, and other pertinent information relating to the transaction. The buyer portal gives access to the buyer to the same information and sale documentation 210.

The core engine 200, in some embodiments, is configured to retrieve data from a deal database 190. The deal database 190 allows for the storage of information and documentation that is shown through the buyer portal and the seller portal.

In some embodiments, the buyer and the seller make offers and/or negotiate the particulars of the deal for the item to be sold. Once the particulars are agreed to (including the purchase price), the core engine 200 may be configured to generate the appropriate sale documentation 210. The sale documentation is then presented to the buyer and the seller for any and all signatures. Such signatures may be through E-sign or other electronic means.

Once the buyer and the seller have both signed the sale documentation, a deal validation engine 285 verifies that the buyer information matches the seller information and sale documentation indicates an agreed upon price for the item for sale.

Once the deal validation engine 285 verifies the information, a transfer engine 235 (a subcomponent of the core engine 200) may transfer the agreed upon funds via a settlement engine 240. The funds are transferred, and the seller is granted access to the funds instantly. The instantaneous nature of the transfer without holds or waiting periods allows the user to have peace of mind regarding the transaction. Such intrabank transfer at the Financial Custodian 170 allows for a much more immediate settlement of the transaction than is possible with conventional systems.

The system 100 may be utilized to implement a computer-implemented method. In some embodiments, the computer-implemented method includes claim 1.

In some embodiments, the computer-implemented method further includes sending sale documentation for signature to the seller with the terms agreed to by the buyer. In some embodiments, the computer-implemented method further includes sending sale documentation for signature to the buyer with the terms agreed to by the seller. In some embodiments, the determining that the sale documentation for signature has been signed by the buyer and the seller before performing the intrabank transfer of the funds from the Buyer Internal Bank Account to the Seller Internal Bank Account.

In some embodiments, the computer-implemented method further includes funding the Buyer Internal Bank Account from a Buyer External Bank Account associated with the buyer. In some embodiments, determining the terms of the sale agreed to by the buyer.

In some embodiments, the computer-implemented method further includes determining the terms of the sale agreed to by the seller.

Disclosed herein is a computer system. The computer system includes one or more processors and memory including instructions which, when accessed by the one or more processors, cause the one or more processors to establish a Seller Internal Bank Account for a seller and a Buyer Internal Bank Account for a buyer under a Financial Custodian and determine whether terms of a sale agreed to by the buyer match terms of a sale agreed to by the seller. The memory includes further instructions which cause the one or more processors to perform an intrabank transfer of funds from the Buyer Internal Bank Account to the Seller Internal Bank

Account upon determining that the terms of the sale agreed to by the buyer match the terms of the sale agreed to by the seller, where the seller is granted immediate access to the funds.

In some embodiments, the memory includes further instructions which cause the one or more processors to Send sale documentation for signature to the seller with the terms agreed to by the buyer.

In some embodiments, send sale documentation for signature to the buyer with the terms agreed to by the seller.

In some embodiments, determine that the sale documentation for signature has been signed by the buyer and the seller before performing the intrabank transfer of the funds from the Buyer Internal Bank Account to the Seller Internal Bank Account.

In some embodiments, fund the Buyer Internal Bank Account from a Buyer External Bank Account associated with the buyer.

In some embodiments, determine the terms of the sale agreed to by the buyer.

In some embodiments, determine the terms of the sale agreed to by the seller.

Referring now to FIG. 3, a schematic diagram of a transaction system is shown, according to one or more embodiments of the invention, with a more detailed description of the core engine 200. As is shown, the transaction system includes a network 60 that allows for the core engine 200 to communicate with a Seller External Bank Account 150, a Buyer External Bank Account 160, and the Financial Custodian 170. The Financial Custodian 170 may be similar to what was described in conjunction with FIGS. 1 and 2.

Although the core engine 200 is shown and described with certain components and functionality, other embodiments of the core engine 200 may include fewer or more components to implement less or more functionality.

The core engine 200 directly or via an API layer (application programming interface) communicates with various other components that may be internal or external with the core engine 200. The core engine 200 is an engine that is configured to verify internal and external bank accounts, analyze deal terms, verify sale documentation, and transfer funds from one internal bank account to another internal bank account instantly. The core engine 200 may be partially computer software based to carry out the functions that are set forth herein. The core engine 200 may have various sub-engines that are configured to perform the functions and tasks described herein. Although the sub-engines are shown and described with certain components and functionality, other embodiments of the sub-engines may include fewer or more components to implement less or more functionality.

A component that the core engine 200 communicates with includes, in some embodiments, a Buyer External Bank Account 160. The Buyer External Bank Account 160 may be located in a separate system that communicates with the core engine 200. In some implementations, the Buyer External Bank Account 160 may be communicated with through an online portal of a user's bank account. The online portal may have individualized data related to a user's particular bank account. In some implementations, a user is prompted by the core engine 200 to input the user's bank login information. Such bank login information may be used by the system to log in to a bank's system or a separate platform. In some implementations, the core engine 200 can be limited in what data are accessed. In some cases, information will be prompted of the buyer. Such inputs may include, but is not limited to, name, social security number and verification, phone, address, etc. Such information may be consistent with the set of processes known as Know Your Customer (KYC), a standard that banks typically follow to verify customers and their information.

The core engine 200, in some embodiments, may be configured to allow a user to input bank information. Upon verification of the buyer and their External Bank Account 160, the core engine 200 may create a Buyer Internal Bank Account 270 within a Financial Custodian 170. This internal bank account may be associated with the external bank account. Funds are then onboarded to the Buyer Internal Bank Account 270 in a manner consistent with Interbank transfers which is not described herein.

A similar process as to what was described above with the buyer is also performed with the seller. In this case, the core engine 200 communicates with Seller External Bank Account 150. The Seller External Bank Account 150 may be located in a separate system that communicates with the core engine 200. In some implementations, the Seller External Bank Account 150 may be communicated with through an online portal of the user's bank account. The online portal may have individualized data related to a user's (seller's) particular bank account. In some implementations, a user is prompted by the core engine 200 to input the user's bank login information. Such bank login information may be used by the system to log in to a bank's system or a separate platform. In some implementations, the core engine 200 can be limited in what data are accessed. In some cases, information will be prompted of the seller. Such inputs may include, but is not limited to, name, social security number and verification, phone, address, etc. Such information may be consistent with the set of processes known as Know Your Customer (KYC), a standard that banks typically follow to verify customers and their information. Such information may be stored in connection with the Seller External Bank Account 150.

The core engine 200, in some embodiments, may be configured to allow a user to input bank information. Upon verification of the seller and their External Bank Account 150, the core engine 200 may create a Seller Internal Bank Account 274 within the Financial Custodian 170. This internal bank account may be associated with the external bank account.

The Financial Custodian 170 allows for an intrabank transfer from the Buyer Internal Bank Account 270 to the Seller Internal Bank Account 274 to be possible. The intrabank nature of the transfer allows for the Financial Custodian to implement an instant transfer of funds between the accounts without any holds or waiting period. The seller is granted access to the funds immediately and can use and move the funds without delay.

The core engine 200, in some embodiments, is configured to facilitate the deal between the buyer and the seller. The core engine 200 may be configured to generate a seller portal and a buyer portal. The seller portal gives access to the seller to sale documentation 210. The sale documentation 210 will include information and legal documents related to the sale. Such documentation may include, but is not limited to, a bill of sale, vehicle information (such as VIN, make, model, year, mileage, etc.) or information for the item to be sold, the title, the offered sale price, and other pertinent information relating to the transaction. The buyer portal gives access to the buyer to the same information and sale documentation 210.

The core engine 200, in some embodiments, is configured to retrieve data from a deal database 190. The deal database 190 allows for the storage of information and documentation that is shown through the buyer portal and the seller portal.

In some embodiments, the buyer and the seller make offers and/or negotiate the particulars of the deal for the item to be sold. Once the particulars are agreed to (including the purchase price), the core engine 200 may be configured to generate the appropriate sale documentation 210. The sale documentation is then presented to the buyer and the seller for any and all signatures. Such signatures may be through E-sign or other electronic means.

Once the buyer and the seller have both signed the sale documentation, a deal validation engine 285 verifies that the buyer information matches the seller information and sale documentation indicates an agreed upon price for the item for sale.

Once the deal validation engine 285 verifies the information, a transfer engine 235 (a subcomponent of the core engine 200) may transfer the agreed upon funds via a settlement engine 240. The funds are transferred, and the seller is granted access to the funds instantly. The instantaneous nature of the transfer without holds or waiting periods allows the user to have peace of mind regarding the transaction. Such intrabank transfer at the Financial Custodian 170 allows for a much more immediate settlement of the transaction than is possible with conventional systems.

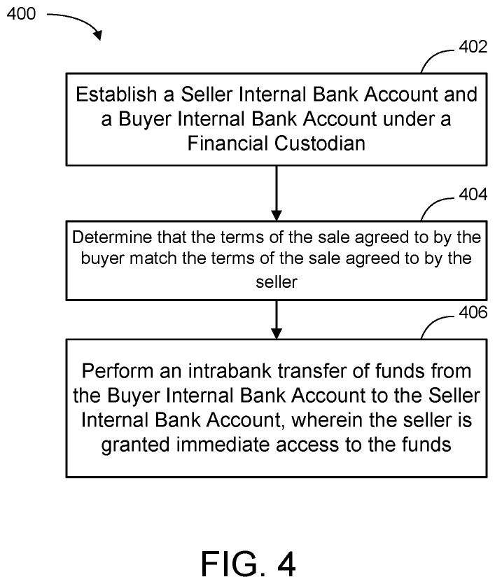

Referring now to FIG. 4, a schematic flow diagram of a method, according to one or more embodiments of the invention, is shown. The method 400 is a general method. Method 400 includes various steps. More or less steps may be used in other embodiments of the invention.

At block 402, the method 400 includes establishing a Seller Internal Bank Account for a seller and a Buyer Internal Bank Account for a buyer under a single Financial Custodian. At block 404, the method 400 includes determining that terms of a sale agreed to by the buyer match the terms of a sale agreed to by the seller. At block 406, the method 400 includes performing an intrabank transfer of funds from the Buyer Internal Bank Account to the Seller Internal Bank Account, wherein the seller is granted immediate access to the funds. The method 400 then ends.

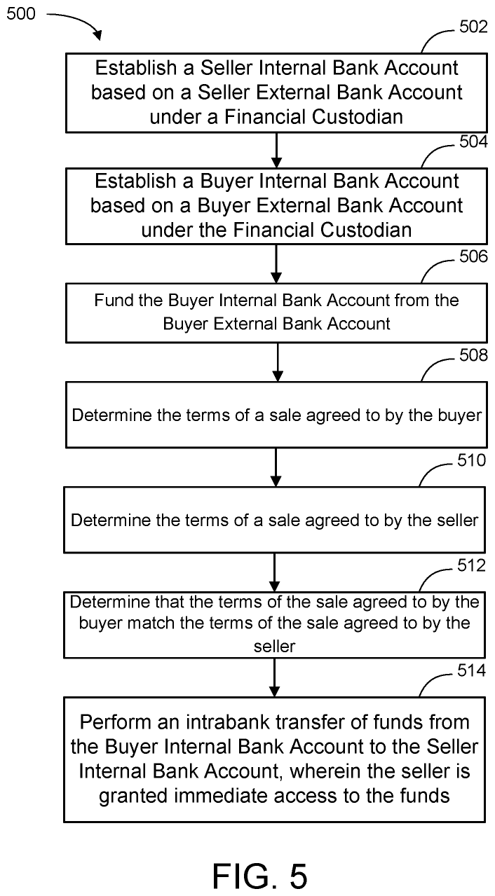

FIG. 5 depicts a schematic flow diagram of a method, according to one or more embodiments of the invention. The method 500 includes various steps. More or less steps may be used in other embodiments.

At block 502, the method 500 includes establishing a Seller Internal Bank Account within a Financial Custodian, the Seller Internal Bank Account associated with a Seller External Bank Account. At block 504, the method 500 includes establishing a Buyer Internal Bank Account within the Financial Custodian, the Buyer Internal Bank Account associated with a Buyer External Bank Account. At block 506, the method 500 includes funding the Buyer Internal Bank Account from the Buyer External Bank Account. At block 508, the method 500 includes determining the terms of a sale agreed to by the buyer. At block 510, the method 500 includes determining the terms of a sale agreed to by the seller. At block 512, the method 500 includes determining that the terms of the sale agreed to by the buyer match the terms of the sale agreed to by the seller. At block 514, the method 500 includes performing an intrabank transfer of funds from the Buyer Internal Bank Account to the Seller Internal Bank Account, wherein the seller is granted immediate access to the funds. The method 500 then ends.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method comprising:
establishing a Seller Internal Bank Account for a seller and a Buyer Internal Bank Account for a buyer under a Financial Custodian;
determining whether terms of a sale agreed to by the buyer match terms of a sale agreed to by the seller; and
performing an intrabank transfer of funds from the Buyer Internal Bank Account to the Seller Internal Bank Account upon determining that the terms of the sale agreed to by the buyer match the terms of the sale agreed to by the seller,
wherein the seller is granted immediate access to the funds.

2. The computer-implemented method of claim 1, further comprising sending sale documentation for signature to the seller with the terms agreed to by the buyer.

3. The computer-implemented method of claim 2, further comprising sending sale documentation for signature to the buyer with the terms agreed to by the seller.

4. The computer-implemented method of claim 3, further comprising determining that the sale documentation for signature has been signed by the buyer and the seller before performing the intrabank transfer of the funds from the Buyer Internal Bank Account to the Seller Internal Bank Account.

5. The computer-implemented method of claim 1, further comprising funding the Buyer Internal Bank Account from a Buyer External Bank Account associated with the buyer.

6. The computer-implemented method of claim 5, further comprising determining the terms of the sale agreed to by the buyer.

7. The computer-implemented method of claim 6, further comprising determining the terms of the sale agreed to by the seller.

8. A computer system, comprising:
one or more processors;
memory including instructions which, when accessed by the one or more processors, cause the one or more processors to:
establish a Seller Internal Bank Account for a seller and a Buyer Internal Bank Account for a buyer under a Financial Custodian;
determine whether terms of a sale agreed to by the buyer match terms of a sale agreed to by the seller; and
perform an intrabank transfer of funds from the Buyer Internal Bank Account to the Seller Internal Bank Account upon determining that the terms of the sale agreed to by the buyer match the terms of the sale agreed to by the seller,
wherein the seller is granted immediate access to the funds.

9. The computer system of claim 8, wherein the memory includes further instructions which cause the one or more processors to: send sale documentation for signature to the seller with the terms agreed to by the buyer.

10. The computer system of claim 9, wherein the memory includes further instructions which cause the one or more processors to: send sale documentation for signature to the buyer with the terms agreed to by the seller.

11. The computer system of claim 10, wherein the memory includes further instructions which cause the one or more processors to: determine that the sale documentation for signature has been signed by the buyer and the seller before performing the intrabank transfer of the funds from the Buyer Internal Bank Account to the Seller Internal Bank Account.

12. The computer system of claim 8, wherein the memory includes further instructions which cause the one or more processors to: fund the Buyer Internal Bank Account from a Buyer External Bank Account associated with the buyer.

13. The computer system of claim 12, wherein the memory includes further instructions which cause the one or more processors to: determine the terms of the sale agreed to by the buyer.

14. The computer system of claim 13, wherein the memory includes further instructions which cause the one or more processors to: determine the terms of the sale agreed to by the seller.

15. A computer system comprising:
a core engine comprising one or more processors and configured to:
establish a Seller Internal Bank Account for a seller and a Buyer Internal Bank Account for a buyer under a Financial Custodian;
determine whether terms of a sale agreed to by the buyer match terms of a sale agreed to by the seller; and
perform an intrabank transfer of funds from the Buyer Internal Bank Account to the Seller Internal Bank Account upon determining that the terms of the sale agreed to by the buyer match the terms of the sale agreed to by the seller, wherein the seller is granted immediate access to the funds.

16. The computer system of claim 15, wherein the core engine comprising one or more processors is further configured to send sale documentation for signature to the seller with the terms agreed to by the buyer.

17. The computer system of claim 16, wherein the core engine comprising one or more processors is further configured to send sale documentation for signature to the buyer with the terms agreed to by the seller.

18. The computer system of claim 17, wherein the core engine comprising one or more processors is further configured to determine that the sale documentation for signature has been signed by the buyer and the seller before performing the intrabank transfer of the funds from the Buyer Internal Bank Account to the Seller Internal Bank Account.

19. The computer system of claim 15, wherein the core engine comprising one or more processors is further configured to fund the Buyer Internal Bank Account from a Buyer External Bank Account associated with the buyer.

20. The computer system of claim 19, wherein the core engine comprising one or more processors is further configured to determine the terms of the sale agreed to by the buyer and the seller.
